(19) United States
(12) Patent Application Publication
(10) Pub. No.: US 2018/0355816 A1
(43) Pub. Date: Dec. 13, 2018

(54) DUAL-FUEL INTERNAL COMBUSTION ENGINE

(71) Applicant: GE JENBACHER GMBH & CO OG, Jenbach (AT)

(72) Inventors: Michael HILLEBRECHT, Prague (CZ); Dino IMHOF, Baden (CH); Georg TINSCHMANN, Schwaz (AT)

(21) Appl. No.: 15/780,626

(22) PCT Filed: Dec. 15, 2016
(86) PCT No.: PCT/AT2016/060130

§ 371 Date: May 31, 2018

(30) Foreign Application Priority Data
Dec. 29, 2015 (AT) A 51108/2015

(51) Int. Cl. F02D 41/30; F02D 41/00

(52) U.S. Cl. CPC F02D 41/3064; F02D 41/0027; F02D 2200/1002; F02D 2250/32; F02D 41/3047

(57) ABSTRACT

A dual-fuel internal combustion engine including at least one combustion chamber. The at least one combustion chamber is paired with an inlet valve for a gas-air mixture and an injector for liquid fuel. The internal combustion engine also includes a regulating device which is designed to carry out a switchover in a switchover mode such that a quantity of energy supplied to the at least one combustion chamber by a gas-air mixture is changed, and a quantity of energy supplied to the at least one combustion chamber by the liquid fuel and/or the time of the injection of the liquid fuel is changed. The regulating device is designed to carry out the switchover on the basis of a current load of the dual-fuel internal combustion engine, wherein the regulating device is designed to select an excess air coefficient of the gas-air mixture in the switchover mode, the coefficient being larger than a target excess air coefficient in a pilot operation.

### TECHNOLOGY FIELD

Embodiments of the disclosure relate to a dual-fuel internal combustion engine with the features of the preamble of claim 1 and a method for switchover by a dual-fuel internal combustion engine with the features of the preamble of claim 9.

### BACKGROUND

In U.S. Pat. No. 6,250,260 B1, US 2002/0007805 A1, U.S. Pat. No. 4,708,094 B and US 2014/0373822 A1, dual-fuel internal combustion engines are disclosed respectively.

Dual-fuel internal combustion engines are typically operated in two operating modes. A distinction is made between an operating mode with a primary liquid fuel supply (“liquid operation” for short; in the case of the use of diesel as a liquid fuel, it is called “diesel operation”) and an operating mode with a primarily gaseous fuel supply, in which the liquid fuel serves as a pilot fuel for initiating combustion (known as “gas operation”, “pilot operation”, or “ignition jet operation”). An example of the liquid fuel is diesel. It could also be heavy oil or another self-igniting fuel. An example of the gaseous fuel is natural gas. Other gaseous fuels, such as biogas, etc., are also suitable.

In pilot operation, a small quantity of liquid fuel is introduced into a piston cylinder unit as a so-called pilot injection. As a result of the conditions prevailing at the time of injection, the introduced liquid fuel ignites and detonates a mixture of gaseous fuel and air present in a combustion chamber of the piston cylinder unit. The quantity of liquid fuel in a pilot injection is typically 0.5-5% of the total amount of energy supplied to the piston cylinder unit in a work cycle of the internal combustion engine.

To clarify the terms, it is defined that the internal combustion engine is operated in pilot operation or in diesel operation. With regard to the control device, the pilot operation of the internal combustion engine is referred to as a pilot mode and a liquid operation of the internal combustion engine is referred to as a liquid mode. In addition, there is a mixed operation. The time of injection (or start of injection, SOI) refers to the beginning of an injection of liquid fuel, or, for example, the beginning of a duration of current flow of an injector.

The prior art also provides for a switchover mode, which serves the switchover between different operating modes. During a switchover from a liquid operation to a pilot operation, for example, the amount of energy supplied to the at least two combustion chambers through the gas-air mixture is increased, and the quantity of liquid fuel supplied to the at least two combustion chambers are reduced.

The substitution rate indicates the proportion of the energy supplied to the internal combustion engine in the form of the gaseous fuel. Substitution rates of between 95 and 99.5% are targeted. Such high substitution rates require a design of the internal combustion engine, for example in terms of the compression ratio as it corresponds to that of a gas engine. The sometimes conflicting demands on the internal combustion engine for a pilot operation and a liquid operation lead to compromises in the design, for example in terms of the compression ratio. There is also a mixed operation, in which substitution rates of less than 95% are used.

US 2007/0000456 A1 discloses a dual-fuel internal combustion engine with the features of the preamble of claim 1. A disadvantage of this is that an undesirable deviation of the rotational speed or of the torque up to the point of overfueling can occur during a switchover phase, for example from liquid operation to pilot operation. In a critical case, too much energy is supplied to the internal combustion engine. Furthermore, it has become evident that dual-fuel internal combustion engines from the prior art, in particular those with central gas mixers, and especially with low and medium loads, require a relatively long time for the switchover.

Internal combustion engines of this type may have a central gas mixer for the at least two combustion chambers. The distance of the at least two combustion chambers from the at least one gas mixer results in a transport delay of the gas-air mixture. The disadvantage of this is that the internal combustion engine can therefore behave unpredictably in the switchover phase.

### BRIEF DESCRIPTION

The object of embodiments of the disclosure is to provide a dual-fuel internal combustion engine of this type and a corresponding method in which a more uniform and predictable behavior can be achieved than in the prior art in the switchover phase.

This object is achieved with regard to the dual-fuel internal combustion engine with the features of claim 1. With regard to the method, this object is achieved with the features of claim 10.

Embodiments of the disclosure are based on the finding that the maximum cylinder pressure or the knock limit is a hard constraint for the switchover duration. Exceeding the same may result in damage to the internal combustion engine. As a result of a load-dependent switchover, reserves in relation to the maximum cylinder pressure and the knock limit can be utilized. A predictable behavior of the dual-fuel internal combustion engine can thereby be achieved. In addition, it is possible to achieve a faster switchover between the different operating modes.

The control device is designed to select an excess air coefficient of the gas-air mixture, which is larger in comparison to a target excess air coefficient in a pilot operation. The increasing of the excess air coefficient of the gas-air mixture initially contributes to moving an operating point of the at least one combustion chamber away from the knock limit. In addition, a leaner gas-air mixture allows a greater margin for the control or regulation of the injector of liquid fuel (e.g. by increasing the quantity of liquid fuel). This contributes to an improved control or regulation of the dual-fuel internal combustion engine during switchover, as an intervention by means of the injector can occur relatively quickly, in an embodiment, for individual cycles.

Embodiments of the disclosure are defined in the dependent claims.

The control device can be designed to select a longer switchover duration the higher the load is. The reduced reserves in relation to the maximum pressure in the at least one combustion chamber or the knock limit can thus be designed accordingly.

The control device can be designed to select a time of injection of the liquid fuel in the switchover mode later than a target time of injection in pilot operation. A moving away from the knock limit can also be achieved by a later time of injection. This case also gives a greater margin for the control or regulation of the injector of liquid fuel (e.g. by increasing the quantity of liquid fuel). This has the previously mentioned positive effect of a further improved control or regulation of the dual-fuel internal combustion engine during switchover.

The control device can be designed to perform the switchover quasi-stationary with the occurrence of a load change. This represents a particularly simple way of controlling or regulating the dual-fuel internal combustion engine, as dynamic effects do not have to be taken into account. The following is an example of a quasi-stationary switchover: A request for a modified load occurs essentially at the same time as a request to perform a switchover to another operating mode. During switchover, interpolated load values are provided for short time intervals. During the time intervals, the dual-fuel internal combustion engine is controlled or regulated in a stationary state in accordance with the load values associated with the time intervals.

The control device can be designed to perform the switchover dynamically when a load change occurs. Taking into account the dynamic effects that occur, for example, during the switchover in conjunction with a modified load, a very accurate control or regulation can be achieved.

This results in a very high certainty of avoiding maximum cylinder pressures that are too high and the exceeding of the knock limit. Furthermore, almost all reserves in the control and regulation can be utilized to achieve a switchover as quickly as possible. In addition, as a result of the exact control and regulation in the dynamic range, an increase of unburned hydrocarbons can be avoided during the switchover.

The control device can be designed to lower an excess air coefficient of the gas-air mixture at a load increase above a predetermined limit value. The lowering of the excess air coefficient allows a relatively rapid increase of performance. Under certain circumstances, this can cause the combustion to take place too close to the knock limit.

In this case, the control device can be designed to increase an excess air coefficient of the gas-air mixture in the event of a load change in the switchover mode above a predetermined limit
value, and to increase the supplied amount of energy of the liquid
fuel supplied to the at least one combustion chamber and/or change the time of injection of the liquid fuel to a later time. In certain situations, the excess air coefficient can no longer be increased, e.g. in liquid operation.

The increasing of the excess air coefficient of the gas-air mixture contributes, as already mentioned, to moving an operating point of the at least one combustion chamber away from the knock limit. Whether the excess air coefficient will increase or decrease depends, as also mentioned, on the knocking tendency (distance from the knock limit) to be expected.

When increasing the excess air coefficient of the gas-air mixture to avoid knocking or pressures that are too high, the amount of energy, which is supplied by liquid fuel to the at least one combustion chamber, can be increased.

In general, the amount of energy supplied to the combustion chambers by the gas-air mixture or liquid fuel is controlled either by the respective quantity of liquid fuel that is injected into the at least two combustion chambers through the injector or the quantity of gas admixed through the at least one gas mixer with an air stream. However, this is not the case in all situations. For example, in the case of a dual-fuel internal combustion engine, a turbocharger is used with a device for setting the charge pressure (blow-off valve or wastegate), the quantity of admixed gas can be reduced, and at the same time the charge pressure can be increased. It should be noted here that in mixed-charged internal combustion engines, the setting of the mixture charge pressure is intended, and that in air-charged internal combustion engines, the setting of the charge pressure is intended.

The amount of energy supplied to the at least two combustion chambers through the gas-air mixture can then be essentially identical. These relationships are known to persons skilled in the art and the amount of energy supplied to the at least two combustion chambers can usually be calculated relatively easily (for example, from the amount of supplied fuels).

An additional possible regulation or control intervention consists of changing the time of the injection of the liquid fuel to a later time. The combustion efficiency can thereby be influenced.

The measures
changing the excess air coefficient of the gas-air mixture,
changing the amount of energy of injected liquid fuel, and
changing the time of injection of the liquid fuel

are, in an embodiment, deployed in accordance with the order specified. Changing the excess air coefficient of gas-air mixture is a relatively slow procedure, which is why this is used first and why, in an embodiment, a certain safety margin is left. This safety margin can be compensated by the two second measures. Choosing to change the amount of energy of injected liquid fuel is preferred, since a reduction of the efficiency of the combustion is accompanied by changing the time of the injection of the liquid fuel. It should be noted that the changing of the excess air coefficient of the gas-air mixture normally works for the whole dual-fuel internal combustion engine, i.e. for all combustion chambers. In contrast, the injection of liquid fuel (quantity or time) for each combustion chamber can be influenced individually by the injectors.

### BRIEF DESCRIPTION OF THE DRAWINGS

Further advantages and details of the disclosure can be found in the figures and the related description of the figures. They are as follows:

FIG. 1 a schematic representation of a dual-fuel internal combustion engine and

FIG. 2A and 2B diagrams that show the switchover strategy.

### DETAILED DESCRIPTION

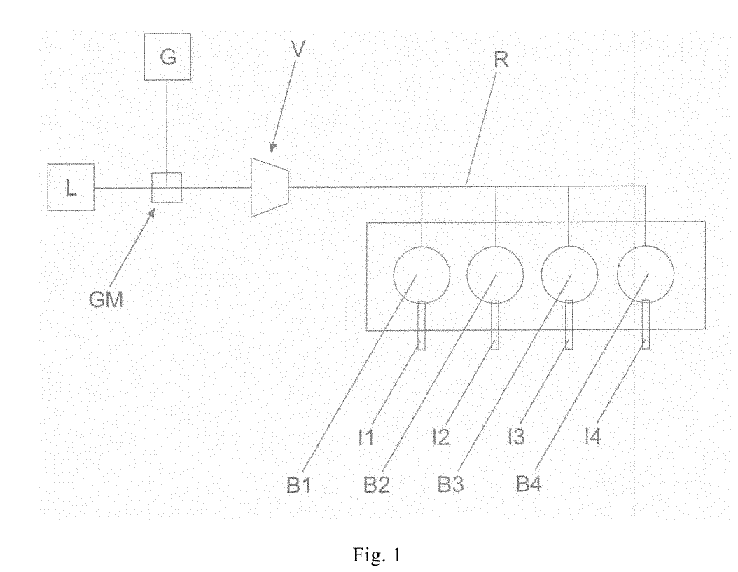

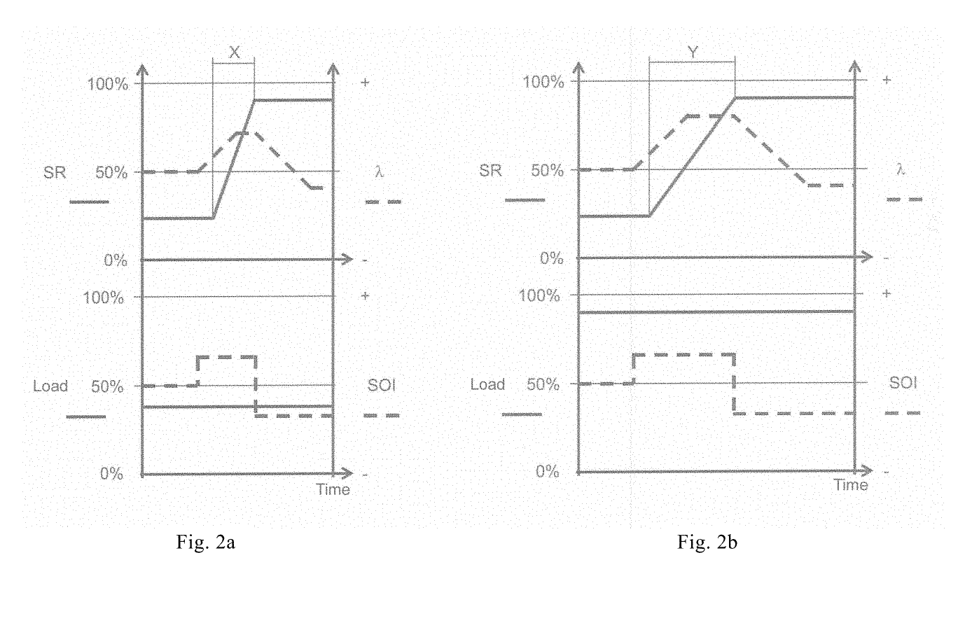

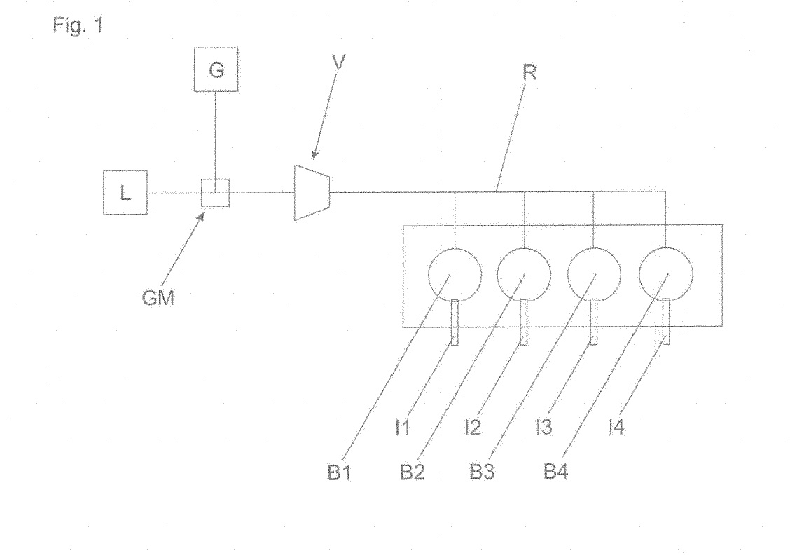

FIG. 1 shows schematically a dual-fuel internal combustion engine according to the disclosure. It has four combustion chambers B1 to B4, which can be supplied with liquid fuel, in this case diesel, via the injectors I1 to I4.

To create the gas-air mixture, a central gas mixer GM is provided, which is connected to an air supply L and a gas reservoir G, e.g. a tank. The gas-air mixture produced in the central gas mixer GM is fed to the combustion chambers B1 to B4 via a gas-air mixture supply R. Downstream of the gas mixer GM, a compressor V of a turbocharger (mixed-charged internal combustion engine) is also provided. However, the gas mixer GM could also be arranged downstream of the compressor V in the air supply (air-charged internal combustion engine). The number of combustion chambers B1 to B4 is purely exemplary.

Embodiments of the disclosure can be used in dual-fuel internal combustion engines with 2, 4, 6, 8, 10, 12, 14, 16, 18, 20, 22 or 24 combustion chambers. Reciprocating piston engines can be used, i.e. the combustion changes are arranged in piston cylinder units.

Embodiments of the disclosure can, in an embodiment, be used in a stationary internal combustion engine, for marine applications or mobile applications such as so-called “non-road mobile machinery” (NRMM), in an embodiment, as a reciprocating piston engine. The internal combustion engine can be used as a mechanical drive, e.g. for the operation of compressor systems or can be coupled with a generator to a genset for generating electrical energy.

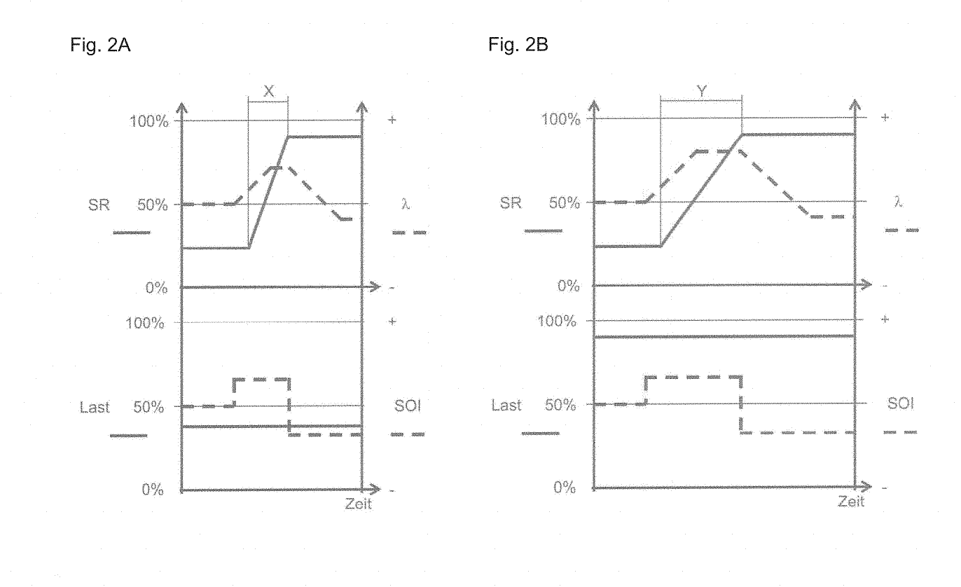

FIGS. 2A and 2B each show two diagrams one above the other, whereby in the upper diagram the substitution rate SR (solid line) and the excess air coefficient λ of the gas-air mixture (dashed line) are plotted against time, and in the lower diagram each load (solid line) and the time of injection SOI (dashed line) of the liquid fuel is plotted against time. For the time of injection SOI, a higher point on the dashed curve means a later time of injection SOI, thus closer to the upper dead center for the respective cylinder in a reciprocating piston engine.

As can be seen from the graphs for the load, these examples are switchovers in the stationary operation of the internal combustion engine at relatively low (FIG. 2A) and relatively high (FIG. 2B) loads.

The substitution rate SR shown in the upper diagrams is linearly increased from a first constant value to a second constant value. This is done in the case of low load (FIG. 2A) over the indicated duration X and at high load (FIG. 2B) over the indicated period Y. As can be seen, the duration chosen with relatively low load is significantly shorter than at relatively high load. This results in time being saved in the switchover duration (except in the case of maximum load).

According to embodiments of the disclosure, during the switchover (see FIG. 2A and 2B) the excess air coefficient λ is increased depending on the load, which serves to prevent knocking and overfueling. The load dependency can manifest itself in the duration, during which the excess air coefficient is λ increased, as well as the level by which the excess air coefficient is λ increased.

Different actuators on the internal combustion engine can be used to increase the excess air coefficient λ of the gas-air-mixture. Examples are the control or regulation (of course, all combinations of the actuator examples can be used)
of the gas mixer GM
of the blow-off valve (not shown) of a compressor V
of a wastegate (not shown) of an exhaust-gas turbine of a turbocharger
of a throttle valve
of a variable turbine (variable angle of turbine blades of the compressor V)

In practice, the control of, for example, a blow-off valve and/or a wastegate is preferred when compared to the control of the gas mixer GM, if fast regulation or control interventions are necessary.

In order to maintain consistent performance during a switchover with increased excess air coefficient λ, an increased quantity of liquid fuel is injected. The knocking tendency thereby increased is counteracted by moving the time of injection SOI to a later point (see the upper diagrams of FIGS. 2A and 2B).

However, in certain circumstances this will negatively influence the combustion efficiency. A worse combustion efficiency may result in a worse emission behavior. Due to time being saved during the switchover as mentioned previously, this can easily be accepted. All in all, this gives a faster switchover, which minimizes the risk of knocking and overfueling.

To demonstrate how to calculate the combustion efficiency, exemplary reference is made to US 2007/0000456 A1.

The situation represented in FIG. 2A and 2B refers to a stationary switchover. In a quasi-stationary switchover, interpolated load values can be provided for short time intervals. These values serve as a basis for the provision of the values for the excess air coefficient λ according to the principles of a stationary switchover.

Embodiments of the disclosure are not limited to the exemplary embodiments shown. Embodiments of the disclosure can be used for switchovers between all modes of a dual-fuel internal combustion engine. More than one gas mixer GM can be used—for example, a gas mixer GM per cylinder bank with a reciprocating piston engine.

This written description uses examples to disclose embodiments, including the preferred embodiments, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A dual-fuel internal combustion engine, comprising:
at least one combustion chamber, wherein the at least one combustion chamber is paired with an inlet valve for a gas-air mixture and an injector for liquid fuel; and
a control device, which is designed to carry out a switchover in a switchover mode such that
an amount of energy supplied to the at least one combustion chamber by a gas-air mixture is changed, and
an amount of energy supplied to the at least one combustion chamber by the liquid fuel and/or the time of injection of the liquid fuel is change;
wherein the control device is designed to carry out the switchover on the basis of the current load of the dual-fuel internal combustion engine; and
wherein the control device is designed to select an excess air coefficient of the gas-air mixture in the switchover mode, the coefficient being larger than the target excess air number in pilot operation.

2. The dual-fuel internal combustion engine according to claim 1, wherein the control device is designed to select a longer switchover duration the higher the load is.

3. The dual-fuel internal combustion engine according to claim 1, wherein the control device is designed to select, in switchover mode, a time of injection of the liquid fuel later than the target time of injection in pilot operation.

4. The dual-fuel internal combustion engine according to claim 1, wherein the control device is designed to carry out the switchover quasi-stationary when a load change occurs.

5. The dual-fuel internal combustion engine according to claim 1, wherein the control device is designed to carry out the switchover dynamically when a load change occurs.

6. The dual-fuel internal combustion engine according to claim 1, wherein the control device is designed to lower an excess air coefficient of the gas-air mixture at a load increase above a predetermined limit value.

7. The dual-fuel internal combustion engine according to claim 1, wherein the control device is designed to increase the amount of energy supplied by the liquid fuel to the at least one combustion chamber and/or change the time of injection of the liquid fuel to a later time in the event of a load change in switchover mode above the predetermined limit.

8. The dual-fuel internal combustion engine according to claim 7, wherein the control device is designed to increase the excess air coefficient of the gas-air mixture in the event of a load change in switchover mode above the predetermined limit.

9. A method for switchover of a dual-fuel internal combustion engine, comprising: making the switchover by
changing an amount of energy supplied to an at least one combustion chamber through a gas-air mixture, and at least one of
changing an amount of energy supplied to the at least one combustion chamber by a liquid fuel and changing a time of injection of the liquid fuel;
wherein the switchover is made on the basis of a current load of the dual-fuel internal combustion engine; and wherein during the switchover an excess air coefficient of the gas-air mixture is selected, the excess air coefficient being larger than a target excess air coefficient in pilot operation.
